(19) United States
(12) Patent Application Publication
(10) Pub. No.: US 2026/0359755 A1
(43) Pub. Date: Nov. 12, 2026

(54) GENERATIVE ARTIFICIAL INTELLIGENCE-BASED WORKFLOW MIGRATION

(71) Applicant: Adobe Inc., San Jose, CA (US)

(72) Inventors: Aayush KAPOOR, Noida (IN); Shani Kumar VISHWAKARMA, Noida (IN)

(21) Appl. No.: 19/201,702

(22) Filed: May 7, 2025

(51) Int. Cl. G06Q 10/0633; G06F 9/54; G06F 40/205; G06F 40/30

(52) U.S. Cl. CPC G06Q 10/0633; G06F 9/541; G06F 40/205; G06F 40/30

(57) ABSTRACT

In various examples, a workflow assistant tool utilizes a machine learning model to automate the migration of workflows between applications. For example, a structured data object of a source workflow of a source application is accessed and parsed to determine workflow activities and transitions of the source workflow. The workflow activities and transitions are serialized into a workflow graph data structure. A summary of the source workflow is generated by prompting a language model with the workflow graph data structure. A mapping of the workflow activities to corresponding workflow activities of a destination application are determined. A summary of a destination workflow is generated by prompting the language model with the summary and the mapping. A structured data object corresponding to the destination workflow is generated based on the summary, which can be utilized by the destination application to display and/or execute the destination workflow.

### BACKGROUND

Users often rely on analytics services to collect and analyze data. Such analytics services can provide insights based on analyzed data. Users, in particular, use analytics services to conduct analytics sessions on data (e.g., user clickstream data) while attempting to gain insights. By way of example, an analytics service can answer questions, such as which mobile devices make the most product conversions. The analytics service can also quantify the success of a marketing campaign. However, a user (e.g., a data analyst) of the analytics services must make many decisions when it comes to gathering insights from an increasing amount of data and capabilities in processing the data, and the user needs to have the ability to quickly query, analyze, and draw inferences from the data. As such, machine learning models are useful tools that when integrated into the analytics service can help users gather insights by filtering, collecting, reviewing, or otherwise interacting with the data and capabilities of the analytics services.

For example, various types of artificial intelligence (AI) models can perform various tasks such as interpreting natural language (NL) prompts and generating outputs based on the natural language prompts. These large language models (LLMs) can be trained on a large corpus of data and extract or otherwise generate responses to questions related to the large corpus of data. For example, an LLM can be integrated with the analytics services to facilitate querying, analyzing, and drawing inferences from the data maintained by the analytics services.

### SUMMARY

Embodiments described herein are directed to a workflow assistant tool that uses a machine learning model to migrate workflows between various marketing and/or analytics services based on natural language (NL) input provided to a language model. Furthermore, in such embodiments, the workflow assistant tool leverages natural language processing (NLP) and machine learning models to automate the migration of workflows (e.g., without user intervention) between applications (e.g., marketing and/or analytics services), allowing users to translate workflows from a source application to a destination application without the need to compose the workflows themselves and/or the technical expertise to interact with the functions and/or operations provided by the various applications to translate the workflows.

In various embodiments, the workflow assistant tool includes a multistep Retrieval-Augmented Generation (RAG)-based prompt engineering pipeline that interprets workflows from a source application to migrate the workflow to a destination application. For example, the workflow assistant tool obtains a structured data object corresponding to a workflow in the source domain-specific language (DSL) format of a source application and a selection of a destination DSL format of a destination application in order to migrate the workflow to the destination format. The workflow assistant tool parses the workflow activities and transitions of the workflow from the structured data object and serializes the workflow activities and transitions into a workflow graph data structure. The workflow graph data structure is used to generate a natural language summary of the source workflow. The workflow activities parsed from the workflow are mapped to corresponding workflow activities of the destination application using similarity computational techniques such as exact name matching, term frequency-inverse document frequency (TF-IDF), and semantic similarity. The natural language summary of the source workflow is adapted to a summary of the destination workflow based on the mapped workflow activities of the destination application, ensuring alignment with the configuration requirements of the destination application. Once the summary of the destination workflow is generated, the workflow assistant tool uses the summary of the destination workflow to generate a structured data object in the DSL format of the destination application, thereby enabling the display and/or execution of the migrated workflow.

### BRIEF DESCRIPTION OF THE DRAWINGS

The present disclosure is described in detail below with reference to the attached drawing figures, wherein:

FIG. 1 depicts an environment in which one or more embodiments of the present disclosure can be practiced.

FIG. 2 depicts an environment in which a workflow assistant tool interprets a workflow from a source application to migrate the workflow to a destination application, in accordance with at least one embodiment.

FIG. 3 depicts a user interface displaying a workflow from a source application that can be migrated from the source application to a destination application, in accordance with at least one embodiment.

FIG. 4 depicts an example process flow for migrating a workflow from a source application to a destination application, in accordance with at least one embodiment.

FIG. 5 depicts an example process flow for mapping workflow activities of a source application to workflow activities of a destination application, in accordance with at least one embodiment.

FIG. 6 is a block diagram of a Large Language Model that uses particular inputs to make particular predictions, according to some embodiments.

FIG. 7 is a block diagram of an example computing environment in which embodiments described herein may be employed.

### DETAILED DESCRIPTION

Various terms are used throughout this description. Definitions of some terms are included below to provide a clearer understanding of the ideas disclosed herein.

As used herein, the term “analytics service” and/or “marketing service” refers to applications, such as cloud computing services, that provide users access to data that is used to generate insights. For example, the analytics service collects, processes, and provides operations that help users gain insights and make decisions. In one example, the analytics service collects marketing campaign data and allows users to process this data to gain insights into successful marketing campaigns. Furthermore, the analytics service, for example, is accessible to the user through an application and can perform various operations using the data to generate content that enables users to determine insights associated with the data. In an embodiment, the analytics service is a service that is capable of tracking, measuring, and analyzing data, such as website traffic and customer behavior. In one example, the analytics service provides user access to a workflow that is used to interact with data maintained by the service. In this way, an analytics service may collect or obtain data from various channels, such as websites, mobile applications, videos, social media, etc. Continuing with this example, through the workflow, the user can interact with the analytics service and breakdown, filter, query, and visualize data. As such, the analytics service may provide real-time data analysis such that various insights related to user interactions, campaign performance, and/or content engagement may be viewed. Various features of an analytics service may include, by way of example only, user journey analysis and conversion analysis (e.g., in association with particular channels or campaigns), predictive insights (e.g., forecasting trends or issues), customized metrics to enable tailored information, and/or the like.

As used herein, the term “workflow” refers to a sequence of tasks or activities that are organized and executed to achieve a specific goal or complete a particular process. Furthermore, in some examples, a workflow involves the systematic arrangement of steps, where the steps represent a distinct action and/or operation to be performed (e.g., by an application and/or service frontend). In an embodiment, the workflows define a process and/or data flow between one task to another, specifying the order in which tasks should be completed and the dependencies (e.g., transitions) between them. In various embodiments, the workflow includes a set of segments and a set of conditions corresponding to features, operations, and/or tools provided by the application and/or the analytics service. For example, the workflow includes a first workflow activity to analyze data, a second workflow activity to perform audience segmentation, and a third workflow activity to generate a personalized email for the audience segment.

As used herein, the term “workflow activity” refers to a discrete, configurable unit within a workflow that performs a specific function or task. For example, a particular workflow activity represents an individual step in a sequence of actions designed to achieve a particular goal or complete a process represented by a workflow. In various embodiments, workflow activities include operations such as data enrichment, filtering, sorting, sending notifications, or executing business logic. In one example, a workflow activity is defined by its inputs, outputs, and the conditions under which it operates. In the context of marketing and analytics services, for example, workflow activities enable the automation and orchestration of tasks, allowing users to create, edit, and manage complex workflows. In various embodiments, users provide natural language inputs to the workflow assistant tool to cause the machine learning model to generate workflow activities.

A “graph data structure,” such as a knowledge graph, is a structured representation of information that organizes entities and their relationships in a graph format (e.g., as interconnected nodes and edges). Entities, such as objects, events, situations, or abstract concepts, are referred to as “nodes,” and relationships between the nodes are referred to as “edges.” In this regard, a “workflow graph data structure” refers to a graph data structure representing a workflow where each workflow activity of the workflow is represented as a node, referred to as a “workflow activity node” and edges represent the transitions (e.g., dependencies) between each of the workflow activities. For example, an example workflow graph data structure includes a first workflow activity node representing a workflow activity to analyze data, a second workflow activity node representing a workflow activity to perform audience segmentation, a third workflow activity node representing a workflow activity to generate a personalized email for the audience segment, a first edge representing the transition between the first and second workflow activity node indicating that the second workflow activity node is dependent on the first workflow activity node, and a second edge representing the transition between the second and third workflow activity node indicating that the third workflow activity node is dependent on the second workflow activity node. In various embodiments, the workflow graph data structure is defined using incident encoding. For example, incident encoding can optimize description of a graph data structure to an LLM by describing the nodes of the graph and how each node of the graph is connected to the other.

As used herein, the term “workflow assistant” refers to a user interface element of an application that allows a user to interact with a machine learning model. By way of example, the workflow assistant includes a query box, a chat box, and/or other interface that allows the user to submit queries (e.g., natural language questions) and obtain workflows and/or workflow activities generated by a machine learning model. In various embodiments, the workflow assistant provides an interactive interface allowing users to input a selection of a workflow from a source application, a selection of a destination application (e.g., also referred to as a target application), and a selection of a user interface element to facilitate the automated migration of the workflow from the format of the source application to the format of the destination application. In various embodiments, the workflow assistant provides an interactive interface allowing users to input a natural language query to the machine learning model to facilitate the processing of data and/or generation of workflows. In various embodiments, the workflow assistant includes various user interface elements to facilitate interactions with the machine learning model such as: a message area where queries from the user and response from the machine learning model are displayed; an input box to provide natural language queries and/or prompts; a send button to submit natural language queries and/or prompts; and a workspace to view, edit, create, and/or execute workflows.

As used herein, the term “workflow assistant tool” refers to an application service, or other executable code that is integrated with the application, the marketing service, and/or the analytics services and provides a machine learning model that facilitates the automated migration of a workflow from a source application to a destination application. For example, the workflow assistant tool is integrated into the application (e.g., through the workflow assistant user interface element) and the analytics service, allowing the user to provide input through the workflow assistant of the application, and in turn, the workflow assistant tool causes the machine learning model to migrate workflows.

As used herein, the term “Retrieval-Augmented Generation” (RAG) refers to a technique that enhances the capabilities of machine learning models by incorporating information retrieval. For example, RAG modifies interactions with a LLM so that the LLM responds to user queries by referencing a specified set of documents, using this information to augment the data drawn from its own training. This allows LLMs to provide more accurate and domain-specific responses by leveraging external, up-to-date information. In various embodiments, RAG is used to generate prompts to enable the machine learning model of the workflow assistant tool to migrate workflows and/or generate workflows and/or workflow activities based on augmented data.

Conventional systems for configuring workflows in marketing and analytics services are often complex and time-consuming. These systems require users to have a deep understanding of user interfaces, internal structures, and data models. Furthermore, the process of manually setting up parameters, identifying tables and columns, determining relationships, and applying functions and operators can be tedious and is error-prone. In addition, different marketing services and/or analytics services provide different functions, operations, and user interfaces that add to the complexity of setting up workflows. Furthermore, these different services operate using domain-specific languages, and knowledge or experience using one service does not necessarily translate to other services.

In addition, modern computing systems maintain, track, store, and generate large amounts of data that can be stored in various data stores. For example, customer data and sales data can be updated and generated frequently. In addition, this data is often stored in different databases using different schemas that can add to the complexity and amount of knowledge required by users to configure and generate workflows. Furthermore, database tables, in modern computing environments, can link to other databases using different schemas, which are not necessarily intuitive and/or user-friendly. Therefore, determining the location of relevant data when generating workflows adds additional layers of complexity requiring further technical expertise to efficiently and easily configure these workflows.

This complexity results in a steep learning curve and significant time investment, making it challenging for users to efficiently create and manage workflows. In general, this shortcoming is particularly challenging because users of these services may be non-technical users with experience, training, and backgrounds in other fields. For example, users of these various marketing and analytics services may have backgrounds and experience in business and advertising with little to no experience in computer engineering and computer programing. Conventional systems provide little to no automated support for workflow migration or workflow generation and, therefore, require these users to take the time to learn the technical aspect of these services. For example, users may be required to search a knowledge base or technical descriptions of various functions and operations provided by these services.

In contrast, embodiments described herein include a generative artificial intelligence (AI)-based workflow assistant tool that utilizes NLP to automate, on behalf of the user, the migration of workflows from a source application to a destination application. This workflow assistant tool allows users to migrate workflows between applications using NLP, significantly reducing the time and complexity involved in workflow configuration. For example, workflow assistant tools help process, digest, understand, query, or otherwise interact with documentation, websites, the Internet, or other collections of documents to help the user generate, configure, and/or modify workflows in order to migrate workflows between different marketing and analytics services. For example, a machine learning model, such as an LLM, is trained and is used as an AI assistant to perform various operations in connection with migrating workflows between particular marketing and/or analytics services.

Accordingly, embodiments described herein generally relate to a multistep RAG-based prompt engineering pipeline of the workflow assistant tool that interprets workflows encoded or otherwise stored in a structured data object in various domain-specific language (DSL) formats of different applications, such as JavaScript Object Notation (JSON) format, Extensible Markup Language (XML) format, YAML, and/or the like. For example, a user can request to migrate a workflow from a source application to a destination application, where the workflow sends personalized emails to customers based on their purchase history and engagement with previous campaigns. The workflow assistant tool processes workflow from the source application, identifies the necessary workflow activities and transitions, generates a workflow graph data structure corresponding to the workflow, generates a summary of the workflow for the source application, determines corresponding workflow activities for the destination application, modifies the summary of the workflow based on the workflow activities of the destination application, and generates a structured data object corresponding to the workflow for the destination application without additional user input. This approach not only enhances efficiency and accuracy but also makes workflow migration accessible to non-technical users, providing a scalable and cost-effective solution to migrate workflows between various services.

In one example, the workflow assistant tool obtains a structured data object corresponding to a workflow in the source DSL format of a source application and a selection of a destination DSL format of a destination application in order to migrate the workflow to the destination DSL format. The workflow assistant tool parses the workflow activities and transitions of the workflow from the source structured data object. As the workflow assistant tool can receive multiple source DSL formats, the workflow assistant tool parses the source structured data object into a unified workflow class to normalize source workflows from different formats into a common internal representation to ensure that downstream components can operate on a consistent data structure.

The workflow assistant tool serializes the workflow activities and transitions parsed from the source structured data object into a workflow graph data structure. For example, the workflow graph structure includes of a list of workflow activity nodes and a list of edges with natural language configuration descriptions for each workflow activity node based on the workflow activities, transitions between workflow activities (e.g., sequences of workflow activities), dependencies between workflow activities, and associated parameters of the workflow activities parsed from the source structured data object.

An LLM generates a natural language summary of the source workflow using the workflow graph data structure. The workflow activities parsed from the source workflow are mapped to corresponding workflow activities of the destination application using similarity techniques. For example, for each workflow activity parsed from the source workflow, initially exact name matching is applied to check for exact name matches between the workflow activity name to a workflow activity name of the destination application. If an exact name match is not found, a TF-IDF vectorization technique is used to measure the string similarity between the workflow activity name to workflow activity names of the destination application to find a corresponding workflow activity name of the destination application above a threshold string similarity. If the workflow activity names of the destination application are below a threshold string similarity, a semantic search is applied to compute the semantic similarity between a contextual embedding of a workflow activity description of the workflow activity to contextual embeddings of the workflow activity descriptions of the workflow activities of the destination application. The workflow activity of the destination application with the greatest semantic similarity score to the workflow activity is mapped to the workflow activity.

An LLM generates a natural language summary of the destination workflow using the natural language summary of the source workflow, the mapping, and descriptions of the workflow activities of the destination application. In this regard, the natural language summary of the source workflow is adapted to a summary of the destination workflow based on the mapped workflow activities of the destination application to ensure alignment with the configuration requirements of the destination application. Once the summary of the destination workflow is generated, the workflow assistant tool uses the summary of the destination workflow to generate a structured data object in the DSL format of the destination application using a RAG-based prompt engineering pipeline, thereby enabling the display and/or execution of the migrated workflow.

Advantageously, embodiments described herein enable users to migrate workflows between applications, such as different marketing and/or analytics services, with improved ease and efficiency, enhanced accuracy, scalability, user-friendliness, and cost-effectiveness. For example, by leveraging generative AI and a multistep RAG-based prompt engineering pipeline, the workflow assistant tool ensures the accuracy of the migrated workflows by reducing the likelihood of errors using embodiments described herein and makes the workflows available and/or executable by different applications. Additionally, the workflow assistant tool automates the migration of workflows between applications using generative AI, eliminating the need for a deep understanding of the user interface and internal schema structures of each of the applications. This approach not only enhances efficiency and accuracy but also makes workflow migration accessible to non-technical users, providing a scalable and cost-effective solution for various industries to move workflows between different marketing and/or analytics services.

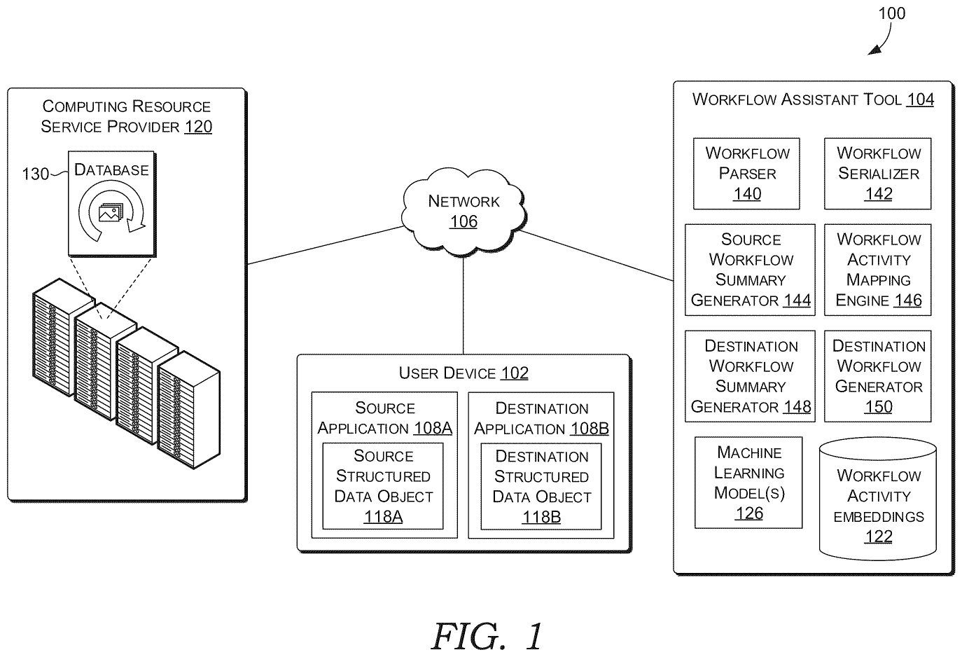

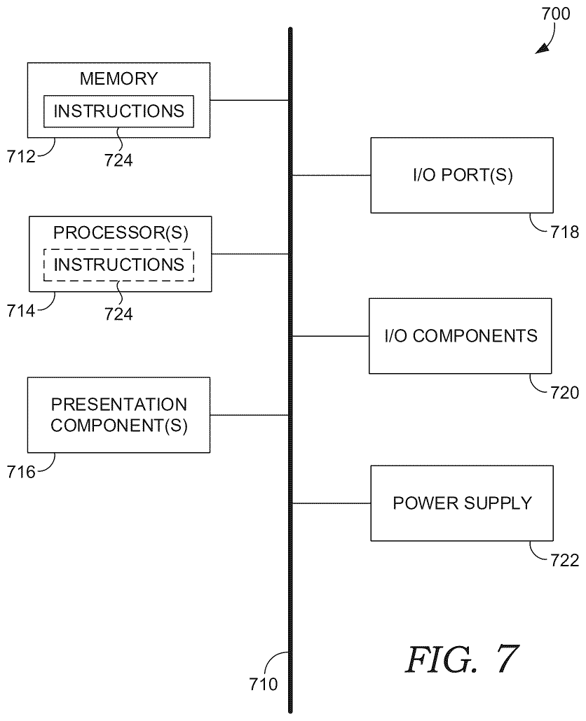

Turning to FIG. 1, FIG. 1 is a diagram of an operating environment 100 in which one or more embodiments of the present disclosure can be practiced. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether for the sake of clarity. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, some functions can be carried out by a processor executing instructions stored in memory, as further described with reference to FIG. 7.

It should be understood that operating environment 100 shown in FIG. 1 is an example of one suitable operating environment. Among other components not shown, operating environment 100 includes a user device 102, a workflow assistant tool 104, and a network 106. Each of the components shown in FIG. 1 can be implemented via any type of computing device, such as one or more computing devices 700 described in connection with FIG. 7, for example. These components can communicate with each other via network 106, which can be wired, wireless, or both. Network 106 can include multiple networks, or a network of networks, but is shown in simple form so as not to obscure aspects of the present disclosure. By way of example, network 106 can include one or more wide area networks (WANs), one or more local area networks (LANs), one or more public networks such as the Internet, and/or one or more private networks. Where network 106 includes a wireless telecommunications network, components such as a base station, a communications tower, or even access points (as well as other components) can provide wireless connectivity. Networking environments are commonplace in offices, enterprise-wide computer networks, intranets, and the Internet. Accordingly, network 106 is not described in significant detail.

It should be understood that any number of devices, servers, and other components can be employed within operating environment 100 within the scope of the present disclosure. Each can comprise a single device or multiple devices cooperating in a distributed environment. For example, the workflow assistant tool 104 includes multiple server computer systems cooperating in a distributed environment to perform the operations described in the present disclosure. Continuing this example, the workflow assistant tool 104 includes a machine learning model 126 executed by a server computer system of the computing resource service provider 120 provided by the computing resource service provider 120 to users such as a user operating the user device 102 through the application 108.

User device 102 can be any type of computing device capable of being operated by an entity (e.g., individual or organization) and that obtains data from the workflow assistant tool 104 and/or a data store that can be facilitated by the workflow assistant tool 104 (e.g., a server operating as a frontend for the data store) and/or the computing resource service provider 120 (e.g., the database 130). The user device 102, in various embodiments, has access to or otherwise maintains the database 130, which stores data useable for marketing and/or analytics. For example, the source application 108A and/or the destination application 108B executes workflows using data maintained in a corresponding database 130 to generate marketing and/or analytics information for a user.

In various embodiments, a workflow can be displayed through source application 108A and destination application 108B via user device 102 to display various workflows. For example, a source structured data object 118A corresponding to a workflow in the DSL format of source application 108A can be used to display and/or execute the workflow by source application 108A. A destination structured data object 118B corresponding to a workflow in the DSL format of destination application 108B can be used to display and/or execute the workflow by destination application 108B. In various embodiments, workflows, when each workflow activity of the workflow is fully configured, when executed by the source application 108A or destination application 108A and/or other component illustrated in FIG. 1 (e.g., the computing resource service provider 120), interacts with relevant data schemas, applies specific conditions, and produces desired outcomes. For example, a corresponding workflow may retrieve customer purchase data, filter by customers who made purchases in the last 30 days, enriches customer profiles with additional information, and sends personalized email campaigns to the filtered customers.

In various embodiments, the user can leverage workflows to automate complex processes, streamline operations, and enhance efficiency. For example, by defining and configuring workflow activities of a workflow, users can automate repetitive tasks, ensure consistency in data processing, determine insights from data, track customer activity, generate marketing campaigns, and achieve accurate and timely results. In an embodiment, workflow activities enable users to create sophisticated workflows that can handle a wide range of tasks, from data queries to multistep processes that query data and perform operations.

In some implementations, user device 102 is the type of computing device described in connection with FIG. 7. By way of example and not limitation, the user device 102 can be embodied as a personal computer (PC), a laptop computer, a mobile device, a smartphone, a tablet computer, a smart watch, a wearable computer, a personal digital assistant (PDA), a global positioning system (GPS) or device, a video player, a handheld communications device, a gaming device or system, an entertainment system, a vehicle computer system, an embedded system controller, a remote control, an appliance, a consumer electronic device, a workstation, any combination of these delineated devices, or any other suitable device.

The user device 102 can include one or more processors and one or more computer-readable media. The computer-readable media can also include computer-readable instructions executable by the one or more processors. In an embodiment, the instructions are embodied by one or more applications, such as source application 108A and destination application 108B shown in FIG. 1. Source application 108A and destination application 108B are each referred to as a single application for simplicity, but the functionality of each can be embodied by one or more applications in practice.

In various embodiments, source application 108A and destination application 108B each include any application capable of facilitating the exchange of information between the user device 102 and the workflow assistant tool 104. For example, source application 108A and destination application 108B each correspond to a different analytics application that tracks, analyzes, and/or optimizes various interactions with customers across multiple communication channels and over an interval of time. Continuing this example, each of source application 108A and destination application 108B can provide data integration, journey mapping, segmentation and personalization, predictive analytics, journey optimization, and reporting and dashboards to provide users with tools to make data-driven decisions. In some implementations, source application 108A and destination application 108B each comprise a corresponding web application, which can run in a web browser, and can be hosted at least partially on the server-side of the operating environment 100. In addition, or instead, source application 108A and destination application 108B can each comprise a corresponding dedicated application, such as an application being supported by the user device 102 and/or workflow assistant tool 104. In some cases, each of source application 108A and destination application 108B can be integrated into the operating system (e.g., as a service). It is therefore contemplated herein that “application” be interpreted broadly. Some example applications include ADOBE® Customer Journey Analytics, a cloud-based analytics service, ADOBE® Campaign Standard (ACS), and ADOBE® Campaign Classic (ACC).

For cloud-based implementations, for example, each of source application 108A and destination application 108B can be utilized to interface with the functionality implemented by the workflow assistant tool 104 and/or a corresponding computing resource service provider 120 of each of source application 108A and destination application 108B. In some embodiments, the components, or portions thereof, of the workflow assistant tool 104 are implemented on the user device 102 or other systems or devices. Thus, it should be appreciated that the workflow assistant tool 104, in some embodiments, is provided via multiple devices arranged in a distributed environment that collectively provide the functionality described herein. Additionally, other components not shown can also be included within the distributed environment.

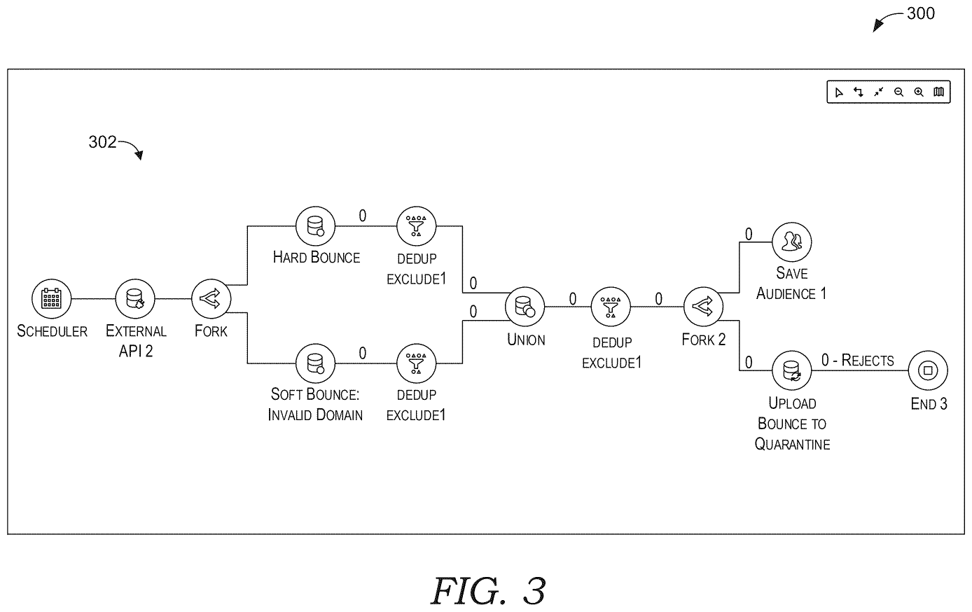

As illustrated in FIG. 1, the user device 102 obtains user input through the workflow assistant tool 104. For example, a user interface of the source application 108A, as illustrated below in FIG. 3, provides an example workflow (e.g., corresponding to source structured data object 118A) that a user selects via a user interface of workflow assistant tool 104. The user can also initiate the migration of the workflow via the user interface of the workflow assistant tool 104 by user input selecting a user interface element to migrate the workflow from source application 108A to destination application 108B. After migration of the workflow via workflow assistant tool 104, a user interface of the destination application 108B can display and/or cause execution of the migrated workflow (e.g., corresponding to destination structured data object 118B).

In an embodiment, the user inputs, via a user interface of workflow assistant tool 104, a selection of a particular workflow in a DSL format of a source application 108A corresponding to source structured data object 118A, a selection of a destination application 108B, and a selection of a user interface element to migrate the workflow from source application 108A to destination application 108B. The workflow assistant tool 104 and/or user device 102, in various embodiments, provides the user input to the workflow assistant tool 104 to enable the workflow assistant tool 104 to generate a workflow in the DSL format of the destination application 108B corresponding to destination structured data object 118B based on the source structured data object 118A. In such embodiments, the workflow assistant tool 104 utilizes one or more machine learning model(s) 126 to perform various tasks to migrate the workflow of source structured data object 118A in the DSL format of the source application 108A to a corresponding workflow of structured data object 118B in the DSL format of the destination application 108B that, as a result of being executed by the destination application 108B and/or other component illustrated in FIG. 1 (e.g., a computing resource service provider 120 and/or database 130 of destination application 108B), causes display of the workflow and/or causes the workflow to be executed.

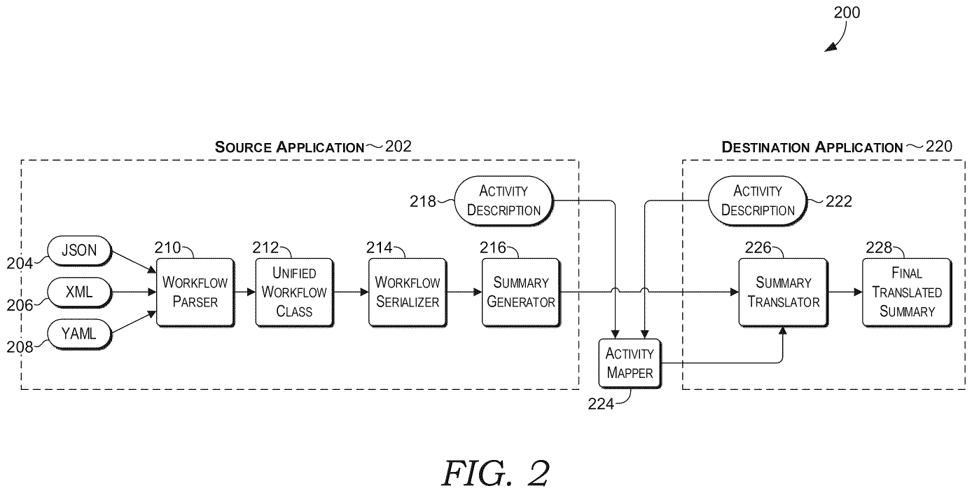

FIG. 2 depicts an environment 200 in which a workflow assistant tool interprets a workflow from a source application to migrate the workflow to a destination application, in accordance with at least one embodiment. In various embodiments, a workflow in a DSL format (e.g., source structured data object 118A) of a source application 202 (e.g., source application 108A) is obtained. The DSL format of the source application 202 can be in a variety of DSL formats, such as JSON 204 format, XML 206 format, YAML 208 format, and/or any other DSL format. A workflow parser 210 (e.g., workflow parser 140) parses the source workflow to output the workflow activities and transitions of the source workflow in a unified workflow class 212. A workflow serializer 214 (e.g., workflow serializer 142) outputs a workflow graph data structure based on the workflow activities and transitions of the source workflow of unified workflow class 212. A summary generator 216 (e.g., source workflow summary generator 144) generates a summary of the source workflow by prompting an LLM with the workflow graph data structure. A workflow activity mapper 224 (e.g., workflow activity mapping engine 146) takes as input workflow activity description 218 of the source application and workflow activity descriptions 222 of a destination application 220 (e.g., destination application 108B) to generate a mapping of the workflow activities of the source workflow to corresponding workflow activities of the destination application. Summary translator 226 (e.g., destination workflow summary generator 144) generates a final translated summary 228 of a destination workflow the destination application 220 by prompting an LLM with (1) the summary of the source workflow, (2) the mapping of the workflow activities of the source workflow to corresponding workflow activities of the destination application, and (3) activity descriptions 222 of the corresponding workflow activities of the destination application. The final translated summary 228 can then be used to generate a destination structured data object (e.g., destination structured data object 118B) corresponding to a workflow for display and/or execution by the destination application 220.

FIG. 3 is an example user interface 300 displaying a workflow from a source application that can be migrated from the source application to a destination application, in accordance with at least one embodiment. Source workflow 302 displayed via a source application (e.g., source application 108A) depicts various workflow activities and transitions between the workflow activities. As can be understood, source workflow 302 is accessed from a structured data object (e.g., source structured data object 118A) in a DSL format of a source application (e.g., source application 108A). In various embodiments, user interface 300 and any other user interfaces described herein comprise interfaces with applications provided using a combination of hardware, firmware, and/or software. The user interfaces can include additional user interface elements to enable users to interact with an application, such as the workflow assistant tool 104, source application 108A and/or destination application 108B of FIG. 1.

Returning to FIG. 1, in various embodiments, workflow parser 140 of the workflow assistant tool 104 accesses (e.g., ingests) source workflows from various DSL formats, such as JSON format, XML format, and YAML format to determine the workflow activities and transitions of the source workflow. In various embodiments, workflow parser 140 parses the source workflow into a unified internal representation, which can be referred to as a “unified workflow class.” In various embodiments, during the parsing process of the source workflow, workflow parser 140 extracts workflow activities, transitions between workflow activities (e.g., sequences of workflow activities), dependencies between workflow activities, and associated parameters of the workflow activities. In various embodiments, by normalizing source workflows from different formats into a unified workflow class, the differences between source formats can be abstracted away, ensuring that downstream components can operate on a consistent data structure. In various embodiments, workflow parser 140 uses any known NLP technique to determine the workflow activities and transitions of the source workflow. As an example, with reference to the example shown in FIG. 3, workflow parser 140 determines a list of workflow activities and transitions of the source workflow 302.

Returning to FIG. 1, in various embodiments, workflow serializer 142 receives as input the workflow activities and transitions of the source workflow from workflow parser 140 and serializes the workflow activities and the transitions into a workflow graph data structure of the source workflow. In various embodiments, workflow serializer 142 outputs a workflow graph structure that includes of a list of workflow activity nodes and a list of edges with natural language configuration descriptions for each workflow activity node of the workflow graph data structure based on the workflow activities, transitions between workflow activities (e.g., sequences of workflow activities), dependencies between workflow activities, and associated parameters of the workflow activities extracted by the workflow parser 140. In various embodiments, workflow serializer 142 outputs a workflow graph structure that is defined using incident encoding. For example, incident encoding can optimize description of a graph data structure to an LLM by describing the nodes of the graph and how each node of the graph is connected to the other.

Returning to FIG. 1, in various embodiments, source workflow summary generator 144 of the workflow assistant tool 104 causes a language model (e.g., machine learning model(s) 126) to generate a summary of the source workflow (e.g., source structured data object 118A of source application 108A) based on a prompt with the workflow graph data structure of the source workflow and instructions to generate the summary. A language model is a statistical and probabilistic tool that determines the probability of a given sequence of words occurring in a sentence (e.g., via next sentence prediction [NSP] or masked language modeling [MLM]). In this way, it is a tool that is trained to predict the next word in a sentence. A language model is called an LLM when it is trained on an enormous amount of data. Some examples of LLMs are Open Pre-trained Transformer (OPT), Fine-tuned Language Net-Text-to-Text Transfer Transformer (FLAN-T5), Bidirectional and Auto-Regressive Transformers (BART), GOOGLE's (RTM) Bidirectional Encoder Representations from Transformers (BERT), and OpenAI's (RTM) Generative Pre-trained Transformer 2 (GPT-2), GPT-3, and GPT-4. For instance, GPT-3 is a large language model with 175 billion parameters trained on 570 gigabytes of text. These models have capabilities ranging from writing a simple essay to generating complex computer codes-all with limited to no supervision. Accordingly, an LLM is a deep neural network that is very large (billions to hundreds of billions of parameters) and understands, processes, and produces human natural language by being trained on massive amounts of text. In embodiments, an LLM generates representations of text, acquires world knowledge, and/or develops generative capabilities. As described, in some embodiments, workflow parser 140, workflow serializer 142, source workflow summary generator 144, workflow activity mapping engine 146, destination workflow summary generator 148, destination workflow generator 150, machine learning model(s) 126, and/or the workflow assistant tool 104 takes on the form of an LLM, but various other machine learning models can additionally or alternatively be used. In this regard, in certain examples, as LLMs are trained on a wide range of unlabeled data available on the internet and are capable of answering questions by inferring and parsing natural language data, the LLM can generate a summary of a workflow, adapt (e.g., translate) a summary of a workflow for a destination application, and/or generate a structured data object in the DSL format of a destination application based on a summary of workflow.

Continuing with the example described in relation to FIG. 3, the following generated summary of a source workflow may be output by the language model:
“The workflow begins with a Scheduler activity, which is configured to trigger at a fixed time of 05:30:00.000, starting from Aug. 3, 2021, and is valid for two days. This initiates an External API activity that fetches data from the endpoint “https://catfact.ninja/fact” without authentication, handling JSON data with specific configurations for data source and destination. The data retrieved is then processed through a Fork activity, which splits the workflow into two parallel Query activities. The first Query filters for hard bounces in email deliveries over the last 10 days, while the second targets soft bounces due to invalid domains over the last 30 days. Both queries are followed by Deduplication activities to remove duplicate entries based on email addresses. The results are then combined using a Union activity, followed by another Deduplication to ensure uniqueness. A second Fork activity then splits the workflow again, leading to a Save Audience activity that creates or updates an audience list, and a Writer activity that updates the database to quarantine bounced emails. The workflow concludes with an End activity, marking its completion.”

Returning to FIG. 1, in various embodiments, the database 130 of source application 108A includes natural language descriptions of predefined workflow activities to provide detailed information regarding the workflow activities available in source application 108A. For example, for a query workflow activity, database 130 can include a natural language description of the predefined “query” workflow activity of source application 108A indicating “a query lets you select a target according to criteria. You can associate a segment code to the query result and insert additional data into it.” Further, in various embodiments, the database 130 of destination application 108B includes natural language descriptions of predefined workflow activities to provide detailed information regarding the workflow activities available in source application 108A.

In various embodiments, the workflow assistant tool 104 generates semantic vector embeddings for the natural language descriptions of the predefined workflow activities of source application 108A using the machine learning model 126 and stores the semantic vector embeddings in the workflow activity embeddings 122 data store. For example, the semantic vector embeddings capture the semantic meaning of each of the predefined workflow activities and are stored in a vector database. As a specific example, relevant documentation for a particular predefined workflow activity can be determined from database 130 using a ranking algorithm, such as Best Match 25. A semantic vector embedding of a particular length (e.g., 1536) for the particular predefined workflow activity can be generated by applying an embedding model (e.g., machine learning model 126), such as OpenAI's (RTM) text-embedding-3-large model, to the relevant documentation. In various embodiments, the workflow assistant tool 104 generates semantic vector embeddings for the natural language descriptions of the predefined workflow activities of destination application 108B using the machine learning model 126 and stores the semantic vector embeddings in the workflow activity embeddings 122 data store.

In various embodiments, workflow activity mapping engine 146 of the workflow assistant tool 104 generates a mapping, which can be referred to as a “workflow activity mapping,” that maps each workflow activity determined by workflow parser 140 to a corresponding predefined workflow activity of the destination application by computing the similarity between each workflow activity determined by workflow parser 140 to a corresponding predefined workflow activity of the destination application. In various embodiments, workflow activity mapping engine 146 computes the similarity to determine the mapping using exact name matching, TF-IDF, and/or a semantic search between a semantic vector embedding of each workflow activity determined by workflow parser 140 to the semantic vector embeddings of the predefined workflow activities of the destination application as stored in workflow activity embeddings 122 data store.

In various embodiments, workflow activity mapping engine 146 initially uses exact name matching to check for exact name matches between source workflow activity names (e.g., workflow activities determined by workflow parser 140) to destination workflow activity names. If an exact name match is found, workflow activity mapping engine 146 maps the destination workflow activity to the corresponding source workflow activity. If no exact name match is found, workflow activity mapping engine 146 uses the TF-IDF vectorization technique to measure the string similarity between source workflow activity names to destination workflow activity names. For example, a string similarity search can be performed by applying string similarity (e.g., cosine similarity) between a word embedding of each source workflow activity name (e.g., computed by machine learning model 126 using TF-IDF and stored in workflow activity embeddings 122 data store) to word embeddings of destination workflow activity names. If a word embedding of a destination workflow activity name is above a threshold string similarity, workflow activity mapping engine 146 maps the destination workflow activity to the corresponding source workflow activity. If more than one word embedding of destination workflow activity names are above a threshold string similarity, workflow activity mapping engine 146 maps the destination workflow activity with the greatest string similarity to the corresponding source workflow activity. If the word embeddings of the destination workflow activity names are below a threshold string similarity, workflow activity mapping engine 146 uses a semantic search to compute the semantic similarity between contextual embeddings (e.g., semantic vector embeddings) of workflow activity descriptions of source workflow activities to contextual embeddings of workflow activity descriptions of destination workflow activities. For example, workflow activity mapping engine 146 of the workflow assistant tool 104 computes the semantic similarity (e.g., cosine similarity) between a contextual embedding of each source workflow activity (e.g., descriptions of workflow activities determined by workflow parser 140) to the contextual embeddings of the predefined workflow activities of the destination workflow activities (e.g., descriptions of the workflow activities of the destination application) to identify the most relevant destination workflow activity. In various embodiments, the destination workflow activity with the greatest semantic similarity score (e.g., or a semantic similarity score above a threshold) to each source workflow activity is determined to be relevant and mapped to the corresponding source workflow activity.

Continuing with the example described in relation to FIG. 3, the following mapping of workflow activities may be output:
Source workflow activity ‘query’ matched with Destination workflow activity ‘query’ via Name Match (Score: 1.0000)
Source workflow activity ‘incremental’ matched with Destination workflow activity ‘incremental’ via Name Match (Score: 1.0000)
Source workflow activity ‘union’ matched with Destination workflow activity ‘union’ via Name Match (Score: 1.0000)
Source workflow activity ‘intersection’ matched with Destination workflow activity ‘intersection’ via Name Match (Score: 1.0000)
Source workflow activity ‘exclusion’ matched with Destination workflow activity ‘exclusion’ via Name Match (Score: 1.0000)
Source workflow activity ‘extract’ matched with Destination workflow activity ‘extract’ via Name Match (Score: 1.0000)
Source workflow activity ‘readAudience’ matched with Destination workflow activity ‘readGroup’ via Closest NLP Embedding (below threshold) (Score: 0.4697)
Source workflow activity ‘saveAudience’ matched with Destination workflow activity ‘saveGroup’ via NLP Embedding Match (Score: 0.5519)
Source workflow activity ‘dedup’ matched with Destination workflow activity ‘dedup’ via Name Match (Score: 1.0000)
Source workflow activity ‘enrich’ matched with Destination workflow activity ‘enrich’ via Name Match (Score: 1.0000)
Source workflow activity ‘start’ matched with Destination workflow activity ‘start’ via Name Match (Score: 1.0000)
Source workflow activity ‘end’ matched with Destination workflow activity ‘end’ via Name Match (Score: 1.0000)
Source workflow activity ‘fork’ matched with Destination workflow activity ‘fork’ via Name Match (Score: 1.0000)
Source workflow activity ‘andjoin’ matched with Destination workflow activity ‘andjoin’ via Name Match (Score: 1.0000)
Source workflow activity ‘schedule’ matched with Destination workflow activity ‘schedule’ via Name Match (Score: 1.0000)
Source workflow activity ‘wait’ matched with Destination workflow activity ‘wait’ via Name Match (Score: 1.0000)
Source workflow activity ‘signal’ matched with Destination workflow activity ‘signal’ via Name Match (Score: 1.0000)
Source workflow activity ‘jstest’ matched with Destination workflow activity ‘jstest’ via Name Match (Score: 1.0000)
Source workflow activity ‘Email delivery’ matched with Destination workflow activity ‘delivery’ via NLP Embedding Match (Score: 0.5597)
Source workflow activity ‘SMS delivery’ matched with Destination workflow activity ‘delivery’ via NLP Embedding Match (Score: 0.5712)
Source workflow activity ‘Push notification delivery’ matched with Destination workflow activity ‘delivery’ via NLP Embedding Match (Score: 0.5727)
Source workflow activity ‘Direct mail delivery’ matched with Destination workflow activity ‘delivery’ via NLP Embedding Match (Score: 0.5266)
Source workflow activity ‘In-App delivery’ matched with Destination workflow activity ‘delivery’ via NLP Embedding Match (Score: 0.5807)
Source workflow activity ‘writer’ matched with Destination workflow activity ‘writer’ via Name Match (Score: 1.0000)
Source workflow activity ‘fileImport’ matched with Destination workflow activity ‘fileImport’ via Name Match (Score: 1.0000)
Source workflow activity ‘fileTransfer’ matched with Destination workflow activity ‘fileTransfer’ via Name Match (Score: 1.0000)
Source workflow activity ‘condition’ matched with Destination workflow activity ‘enrich’ via NLP Embedding Match (Score: 0.5833)
Source workflow activity ‘fileExport’ matched with Destination workflow activity ‘fileExport’ via Name Match (Score: 1.0000)
Source workflow activity ‘setOfService’ matched with Destination workflow activity ‘setOfService’ via Name Match (Score: 1.0000)
Source workflow activity ‘externalApi’ matched with Destination workflow activity ‘js’ via TF-IDF Match (Score: 0.4014)

As can be understood, initially exact name matching used to map a destination workflow activity to a source workflow activity. For example, source workflow activity ‘query’ is matched with destination workflow activity ‘query’ via exact name match. If no exact name match is found for the source workflow activity, TF-IDF (e.g., string similarity) is used to map a destination workflow activity to a source workflow activity. For example, source workflow activity ‘externalApi’ matched with destination workflow activity ‘js’ via TF-IDF match with a string similarity score of 0.4014, which is above a threshold string similarity score of 0.4. If no string similarity is found for the source workflow activity above a threshold string similarity, semantic similarity is used to map a destination workflow activity to a source workflow activity. For example, destination workflow activity ‘saveAudience’ matched with source workflow activity ‘saveGroup’ with a semantic similarity score of 0.5519, which is above a threshold semantic similarity score of 0.5. Even though, destination workflow activity ‘readAudience’ and source workflow activity ‘readGroup’ had a semantic similarity score of 0.4697, which is below the threshold semantic similarity score of 0.5, the workflow activities were matched as it was the greatest semantic similarity with respect to the remaining destination workflow activities.

Returning to FIG. 1, in various embodiments, once the summary of the source workflow and the workflow activity mapping are determined, destination workflow summary generator 148 of the workflow assistant tool 104 causes a language model (e.g., machine learning model(s) 126) to generate a summary of the destination workflow (e.g., for a destination application 118B) based on a prompt with the summary of the source workflow generated by source workflow summary generator 144, the mapping generated by workflow activity mapping engine 146 and instructions to generate the summary. In various embodiments, the prompt to generate the summary of the destination workflow also includes workflow activity descriptions of the workflow activities of the destination application 108B (e.g., from database 130). In various embodiments, the summary of the destination workflow replaces or adjusts workflow activity names, updates parameters, and ensures the summary aligns with the expected workflow configuration requirements of destination application 108B.

Continuing with the example described in relation to FIG. 3, the following summary of the destination workflow for a destination application may be output by an LLM:
“The workflow begins with a schedule activity, which is configured to trigger at a fixed time of 05:30:00.000, starting from Aug. 3, 2021, and is valid for two days. This initiates a js activity that fetches data from the endpoint “https://catfact.ninja/fact” without authentication, handling JSON data with specific configurations for data source and destination. The data retrieved is then processed through a fork activity, which splits the workflow into two parallel query activities. The first query filters for hard bounces in delivery over the last 10 days, while the second targets soft bounces due to invalid domains over the last 30 days. Both queries are followed by dedup activities to remove duplicate entries based on email addresses. The results are then combined using a union activity, followed by another dedup to ensure uniqueness. A second fork activity then splits the workflow again, leading to a saveGroup activity that creates or updates a group list, and a writer activity that updates the database to quarantine bounced emails. The workflow concludes with an end activity, marking its completion.”

As can be understood, the workflow activities of the source product in the summary of the source workflow are replaced with workflow activities of the destination application in the summary of the destination workflow. For example, among other changes, “External API activity” and “Save Audience activity” in the summary of the source workflow is replaced with “js activity” and “saveGroup activity,” respectively, in the summary of the destination workflow.

Returning to FIG. 1, once the summary for the destination workflow for the destination application is generated, destination workflow generator 150 of workflow assistant tool 104 generates a destination structured data object 118B corresponding to a workflow in a DSL format of destination application 108B based on the summary for the destination workflow. In various embodiments, once the destination structured data object 118B is generated, destination application 108B can display the workflow to the end user via user device 102 based on the structured data object 118B. In various embodiments, once the destination structured data object 118B is generated, destination application 108B can cause the workflow to be executed based on the destination structured data object 118B. For example, a user selects a user interface component of a user interface of the destination application 108B via user device 102 to cause the workflow to be executed by destination application 108B based on the destination structured data object 118B.

In various embodiments, destination workflow generator 150 of workflow assistant tool 104 can generate the destination structured data object 118B using various embodiments described in U.S. patent application Ser. No. 19/185,081, which is incorporated herein by reference in its entirety. For example, destination workflow generator 150 of workflow assistant tool 104 can generate the destination structured data object 118B using a RAG-based prompt engineering pipeline. For instance, destination workflow generator 150 of workflow assistant tool 104 can generate the destination structured data object 118B by applying the summary of the destination workflow to a language model. The language model generates a set of suggested workflow activities based on a prompt with the summary of the destination workflow for the destination application and instructions to generate a set of suggested workflow activities. Destination workflow generator 150 performs a semantic search to determine relevant predefined workflow activities available in the destination application based on the suggested workflow activities. For each suggested workflow activity, the predefined workflow activity of the destination application with the greatest similarity score is selected by destination workflow generator 150 as the most relevant predefined workflow activity. Destination workflow generator 150 applies the relevant predefined workflow activities to a language model. Using the relevant predefined workflow activities, the language model generates a workflow graph data structure with natural language configuration descriptions for each workflow activity node of the workflow graph data structure based on a prompt with the summary of the workflow for the destination application and predefined workflow activity nodes corresponding to each of the relevant workflow activities of the destination application. The workflow graph data structure undergoes validation and self-correction procedures by destination workflow generator 150. After the workflow graph data structure is validated by destination workflow generator 150, a destination structured data object 118B is generated by destination workflow generator 150 by translating the workflow graph data structure into a DSL format of the destination application 108B, such as a JSON, XML, and/or the like. In this regard, the destination application 108B can utilize the destination structured data object 118B to display the workflow to the user. In various embodiments, fully configured workflow activities of the destination structured data object 118B are generated using the natural language descriptions of the workflow activities. In this regard, the workflow of the destination structured data object 118B can be executed by the destination application 108B based on the fully configured workflow activities of the destination structured data object 118B.

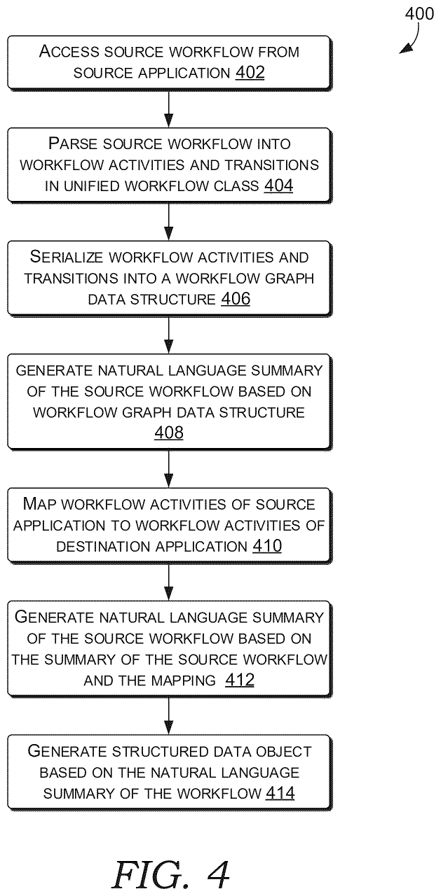

FIG. 4 is a flow diagram showing a method 400 for migrating a workflow from a source application to a destination application, in accordance with at least one embodiment. The method 400 can be performed, for instance, by the workflow assistant tool 104 of FIG. 1. Each block of the method 400 and any other methods described herein comprise a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

At block 402, the process begins with accessing the source workflow from the source application. For example, the workflow data is stored as a structured data object in a particular DSL format of the source application, such as JSON, XML, or YAML

At block 404, the source workflow is parsed to determine workflow activities and transitions and the workflow activities and transitions are output in a unified workflow class. For example, the structured data object of the source workflow is parsed to identify the individual workflow activities that make up the workflow, as well as the transitions or dependencies between the workflow activities. In various embodiments, the unified workflow class is a standardized representation of the workflow that abstracts away the specific details of the DSL format of the source application. In various embodiments, the parsing can use of NLP techniques to interpret the workflow activities and transitions.

At block 406, the workflow activities and transitions are then serialized into a workflow graph data structure. For example, the parsed workflow data is serialized into a graph format, where each node represents a workflow activity and each edge represents a transition between activities. In various embodiments, the workflow activities, the transitions, dependencies between workflow activities, and associated parameters of the workflow activities can be stored in the workflow graph data structure of the source workflow.

At block 408, a natural language summary of the source workflow is generated based on the workflow graph data structure. For example, the natural language summary of the source workflow provides a human-readable representation of the workflow. In various embodiments, the summary is generated using an LLM, such as GPT-4.

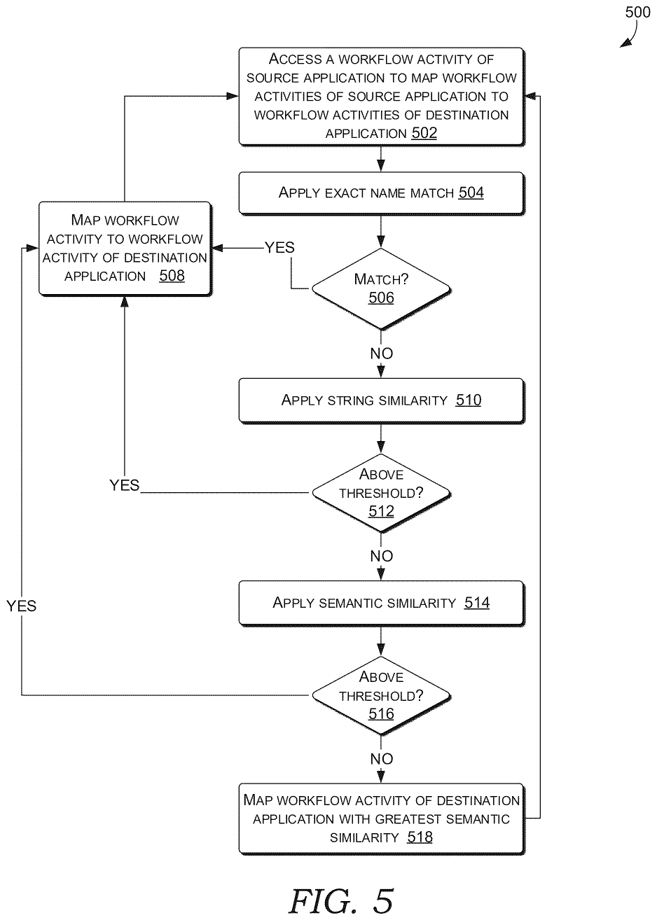

At block 410, the workflow activities of the source application are mapped to the workflow activities of the destination application. For example, corresponding workflow activities in the destination application that match the workflow activities in the source workflow are determined using similarity techniques, such as exact name matching, TF-IDF, and/or semantic similarity. An example of mapping workflow activities of a source application to workflow activities of a destination application is described in more detail with respect to FIG. 5.

At block 412, a natural language summary of the destination workflow is generated based on the summary of the source workflow, the mapping, and/or descriptions of the workflow activities of the destination application. For example, the natural language summary of the destination workflow provides a human-readable representation of the workflow. In this regard, the summary of the source workflow is updated to reflect the mapped activities and/or transitions of the destination application, ensuring that the summary accurately represents the workflow in the context of the destination application. In various embodiments, the summary is generated using an LLM, such as GPT-4.

At block 414, a structured data object is generated based on the natural language summary of the workflow. For example, the summary of the destination application is used to generate a structured data object in the DSL format of the destination application, such as JSON, XML, or YAML. In various embodiments, the structured data object is generated using a RAG-based prompt engineering pipeline. In various embodiments, the workflow can be displayed and/or executed by the destination application using the structured data object.

FIG. 5 is a flow diagram showing a method 500 for mapping workflow activities of a source application to workflow activities of a destination application, in accordance with at least one embodiment. The method 500 can be performed, for instance, by the workflow assistant tool 104 of FIG. 1. Each block of the method 500 and any other methods described herein comprise a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

At block 502, a workflow activity of the source application is accessed (e.g., from the workflow activities parsed from the structured data object corresponding to the source workflow) to map workflow activities of the source application to workflow activities of the destination application. For example, after parsing the structured data object corresponding to the source workflow to determine the workflow activities and transitions of the source workflow, each of the workflow activities are mapped to a corresponding workflow activity of the destination application.

At block 504, an exact name match between the workflow activity of the source application (e.g., from the source structured data object corresponding to the source workflow) to the workflow activities of the destination application. For example, the name of the workflow activity is compared with the names of the workflow activities in the destination application to find exact name matches. If no exact name match is found at block 506, alternative similarity techniques may be employed. If an exact match is found at block 506, the workflow activity is mapped to the corresponding workflow activity in the destination application at block 508. The next workflow activity of the source application (e.g., from the workflow activities parsed from the structured data object corresponding to the source workflow) is then mapped to a corresponding workflow activity of the destination application at block 502 until there are no workflow activities of the source applications remaining to be mapped.

If no exact name match is found at block 506, at block 510, string similarity is applied to map the workflow activity of the source application to a workflow activity of the destination application. For example, the name of the workflow activity of the source application is compared to the names of the workflow activities in the destination application using string similarity algorithms, such as TF-IDF. In various embodiments, string similarity is applied to determine whether a corresponding word embedding of a corresponding name of a workflow activity of the destination application is above a threshold string similarity to a word embedding of a name of the workflow activity of the source application. In various embodiments, various string similarity techniques can be utilized, such as Levenshtein distance, Jaccard similarity, and/or cosine similarity.

If the string similarity score is below a predefined threshold at block 512, alternative similarity techniques may be employed. If the string similarity score is above a predefined threshold at block 512, the workflow activity from the source application is mapped to the corresponding workflow activity in the destination application at block 508. The next workflow activity of the source application (e.g., from the workflow activities parsed from the structured data object corresponding to the source workflow) is then mapped to a corresponding workflow activity of the destination application at block 502 until there are no workflow activities of the source applications remaining to be mapped.

If the string similarity score is below a predefined threshold at block 512, at block 514, semantic similarity is applied to map the workflow activity of the source application to a workflow activity of the destination application. For example, the names and/or descriptions of the workflow activities in the source application and the names and/or descriptions of the workflow activities in the destination application are compared using semantic similarity algorithms. In various embodiments, semantic similarity is applied to determine whether a corresponding contextual embedding of a corresponding description of a workflow activity of the destination application is above a threshold semantic similarity to a contextual embedding of a description of a workflow activity of the source application.

If the semantic similarity score is above a predefined threshold at block 516, the workflow activity from the source application is mapped to the corresponding workflow activity in the destination application at block 508. If the semantic similarity score is below a predefined threshold at block 512, the workflow activity from the source application is mapped to the corresponding workflow activity in the destination application with the greatest semantic similarity score at block 518. The next workflow activity of the source application (e.g., from the workflow activities parsed from the structured data object corresponding to the source workflow) is then mapped to a corresponding workflow activity of the destination application at block 502 until there are no workflow activities of the source applications remaining to be mapped.

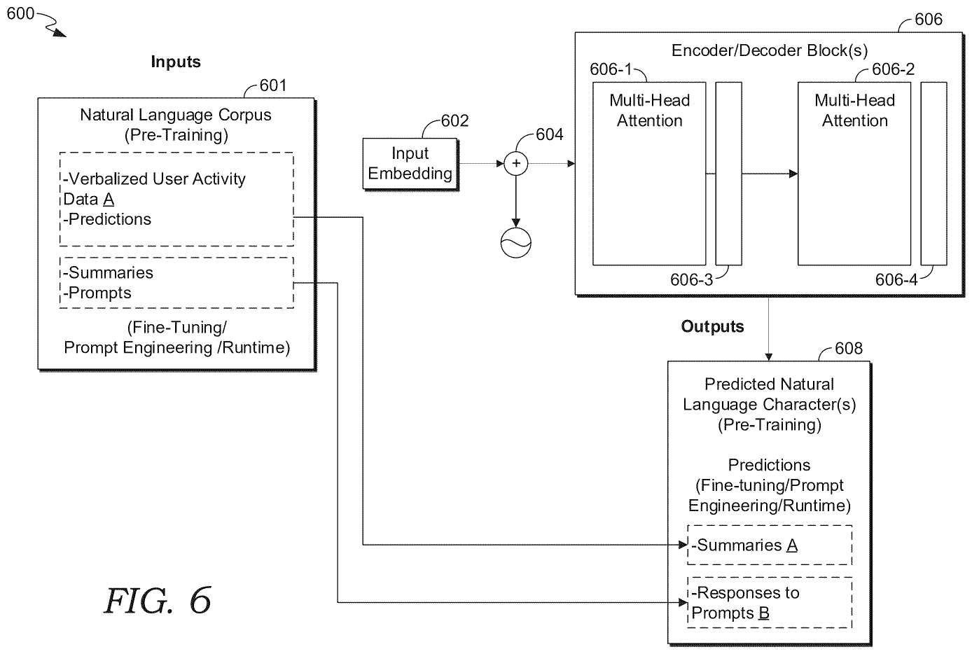

FIG. 6 is a block diagram of a Large Language Model 600 (e.g., a BERT model or GPT-4 model) that uses particular inputs to make particular predictions (e.g., answers to questions), according to some embodiments. In some embodiments, this model 600 represents or includes the functionality as described with respect to the machine learning model(s) 126 of FIG. 1. In various embodiments, the language model 600 includes one or more encoders and/or decoder blocks 606 (or any transformer or portion thereof).

First, a natural language corpus (e.g., various WIKIPEDIA English words or BooksCorpus) of the inputs 601 are converted into tokens and then feature vectors and embedded into an input embedding 602 to derive meaning of individual natural language words (for example, English semantics) during pre-training. In some embodiments, to understand English language, corpus documents, such as textbooks, periodicals, blogs, social media feeds, and the like are ingested by the language model 600.

In some embodiments, each word or character in the input(s) 601 is mapped into the input embedding 602 in parallel or at the same time, unlike existing long short-term memory (LSTM) models, for example. The input embedding 602 maps a word to a feature vector representing the word. However, the same word (for example, “apple”) in different sentences may have different meanings (for example, brand versus fruit). This is why a positional encoder 604 can be implemented. A positional encoder 604 is a vector that gives context to words (for example, “apple”) based on a position of a word in a sentence. For example, with respect to a message “I just sent the document,” because “I” is at the beginning of a sentence, embodiments can indicate a position in an embedding closer to “just,” as opposed to “document.” Some embodiments use a sine/cosine function to generate the positional encoder vector as follows:

PE_{(pos,2i)}=sin(pos/10000^{2i/dmodel})

PE_{(pos,2i+1)}=cos(pos/10000^{2i/dmodel}).

After passing the input(s) 601 through the input embedding 602 and applying the positional encoder 604, the output is a word embedding feature vector, which encodes positional information or context based on the positional encoder 604. These word embedding feature vectors are then passed to the encoder and/or decoder block(s) 606, where they go through a multi-head attention layer 606-1 and a feedforward layer 606-2. The multi-head attention layer 606-1 is generally responsible for focusing or processing certain parts of the feature vectors representing specific portions of the input(s) 601 by generating attention vectors. For example, in Question Answering systems, the multi-head attention layer 606-1 determines how relevant the i^{th} word (or particular word in a sentence) is for answering the question or its relevance to other words in the same or other blocks, the output of which is an attention vector. For every word, some embodiments generate an attention vector, which captures contextual relationships between other words in the same sentence or other sequences of characters. For a given word, some embodiments compute a weighted average or otherwise aggregate attention vectors of other words that contain the given word (for example, other words in the same line or block) to compute a final attention vector.

In some embodiments, a single-headed attention has abstract vectors Q, K, and V that extract different components of a particular word. These are used to compute the attention vectors for every word, using the following formula:

$$Z = softmax ( \frac{Q \cdot {K}^{T}}{\sqrt{Dimension of vector Q , K , or V}} ) \cdot V .$$

For multi-headed attention, there are multiple weight matrices W^{q}, W^{k}, and W^{v} so there are multiple attention vectors Z for every word. However, a neural network may only expect one attention vector per word. Accordingly, another weighted matrix, W^{z}, is used to make sure the output is still an attention vector per word. In some embodiments, after the layers 606-1 and 606-2, there is some form of normalization (for example, batch normalization and/or layer normalization) performed to smoothen out the loss surface, making it easier to optimize while using larger learning rates.

Layers 606-3 and 606-4 represent residual connection and/or normalization layers where normalization recenters and rescales or normalizes the data across the feature dimensions. The feedforward layer 606-2 is a feedforward neural network that is applied to every one of the attention vectors outputted by the multi-head attention layer 606-1. The feedforward layer 606-2 transforms the attention vectors into a form that can be processed by the next encoder block or can make a prediction at 608. For example, given that a document includes the first natural language sequence “the due date is . . . ” the encoder/decoder block(s) 606 predicts that the next natural language sequence will be a specific date or particular words based on past documents that include language identical or similar to the first natural language sequence.

In some embodiments, the encoder/decoder block(s) 606 includes pre-training to learn language (pre-training) and make corresponding predictions. In some embodiments, there is no fine-tuning because some embodiments perform prompt engineering, prompt-tuning, or zero-shot learning. “Prompt engineering” refers to a process of designing or using structured input to the model (referred to as a prompt or prompts) to cause a desired response to be generated by the model. In some embodiments, prompt engineering includes creating the best or optimal prompt, or series of prompts, for the desired user task or output. Accordingly, given a first prompt (which may include target content), if the model produces a first output with a high likelihood of not being the correct response, particular embodiments learn such that a second output (indicative of high likelihood of being the correct response) is always produced when such a first prompt is provided as input. In this way, at model deployment time, no output is ever produced with a low likelihood of being the correct response if the first prompt (or variation thereof) is provided, thereby increasing the accuracy of the model's generative outputs.

Pre-training is performed to understand language, and fine-tuning is performed to learn a specific task, such as learning an answer to a set of questions (in Question Answering systems). In some embodiments, the encoder/decoder block(s) 606 learns what language and context for a word are in pre-training by training on two unsupervised tasks (MLM and NSP) simultaneously or at the same time. In terms of the inputs and outputs, at pre-training, the natural language corpus of the inputs 601 may be various historical documents, such as text books, journals, or periodicals, in order to output the predicted natural language characters in 608 (not make the predictions at runtime or prompt engineering at this point). The encoder/decoder block(s) 606 takes in a sentence, paragraph, or sequence (for example, included in the input [s] 601), with random words being replaced with masks. The goal is to output the value or meaning of the masked tokens. For example, if a line reads, “please [MASK] this document promptly,” the prediction for the “mask” value is “send.” This helps the encoder/decoder block(s) 606 understand the bidirectional context in a sentence, paragraph, or line at a document. In the case of NSP, the encoder/decoder block(s) 606 takes, as input, two or more elements, such as sentences, lines, or paragraphs, and determines, for example, if a second sentence in a document actually follows (for example, is directly below) a first sentence in the document. This helps the encoder/decoder block(s) 606 understand the context across all the elements of a document, not just within a single element. Using both of these together, the encoder/decoder block(s) 606 derives a good understanding of natural language.

In some embodiments, during pre-training, the input to the encoder/decoder block(s) 606 is a set (for example, 2) of masked sentences (sentences for which there are one or more masks), which could alternatively be partial strings or paragraphs. In some embodiments, each word is represented as a token, and some of the tokens are masked. Each token is then converted into a word embedding (for example, 602). At the output side is the binary output for the next sentence prediction. For example, this component may output 1, for example, if masked sentence 2 follows (for example, is directly beneath) masked sentence 1. The output is word feature vectors that correspond to the outputs for the machine learning model functionality. Thus, the number of word feature vectors that are input is the same number of word feature vectors that are output.

In some embodiments, the initial embedding (for example, the input embedding 602) is constructed from three vectors: the token embeddings, the segment or context-question embeddings, and the position embeddings. In some embodiments, the following functionality occurs in the pre-training phase. The token embeddings are the pre-trained embeddings. The segment embeddings are the sentence numbers (that includes the input [s] 601) that are encoded into a vector (for example, first sentence, second sentence, etc., assuming a top-down and right-to-left approach). The position embeddings are vectors that represent the position of a particular word in such a sentence that can be produced by positional encoder 604. When these three embeddings are added or concatenated together, an embedding vector is generated that is used as input into the encoder/decoder block(s) 606. The segment and position embeddings are used for temporal ordering since all of the vectors are fed into the encoder/decoder block(s) 606 simultaneously and language models need some sort of order preserved.

In pre-training, the output is typically a binary value C (for NSP) and various word vectors (for MLM). With training, a loss (for example, cross-entropy loss) is minimized. In some embodiments, all the feature vectors are of the same size and are generated simultaneously. As such, each word vector can be passed to a fully connected layered output with the same number of neurons equal to the same number of tokens in the vocabulary.

In some embodiments, once pre-training is performed, the encoder/decoder block(s) 606 performs prompt engineering or fine-tuning on a variety of question and answer datasets by converting different QA formats into a unified sequence-to-sequence format. For example, some embodiments perform the QA task by adding a new question answering head or encoder/decoder block, just the way a masked language model head is added (in pre-training) for performing an MLM task, except that the task is a part of prompt engineering or fine-tuning. This includes the encoder/decoder block(s) 606 processing the inputs 601 (i.e., the verbalized user activity data, the predictions, summaries, and/or prompts) in order to make the predictions and confidence scores as indicated in 608. Prompt engineering, in some embodiments, is the process of crafting and optimizing text prompts for language models to achieve desired outputs. In other words, prompt engineering is the process of mapping prompts (e.g., a question) to the output (e.g., an answer) that it belongs to for training. For example, if a user asks a model to generate a poem about a person fishing on a lake, the expectation is that it will generate a different poem each time. Users may then label the output or answers from best to worst. Such labels are an input to the model to make sure the model is giving more human-like or best answers, while trying to minimize the worst answers (e.g., via reinforcement learning). In some embodiments, a “prompt” as described herein includes one or more of: a request (e.g., a question or instruction [e.g., write a poem]), target content, a command or instruction, and/or more examples (e.g., one-shot or two-shot examples).

In an illustrative example, in some embodiments, the predictions of the output 608 may be generative text, workflows, workflow activities, structured data objects, or other data, such as those described above. Alternative to prompt engineering or fine-tuning, in some embodiments the inputs 601 and outputs 608 represent “runtime” inputs and outputs. Runtime represents a time after which the model 600 has been trained (e.g., via pre-training and/or fine-tuning and/or prompt engineering), tested, and deployed.

An artificial intelligence (AI) system refers to an artificial intelligence computing environment or architecture that includes the infrastructure and components that support the development, training, and deployment of artificial intelligence models. It provides necessary hardware, software, and frameworks for developers to create and run artificial intelligence applications. An artificial intelligence system may be a cloud-based AI solution that leverages cloud computing infrastructure to develop, train, deploy, and manage AI models and applications. AI models may specifically refer to generative AI models that are designed to generate new data or content that is similar to, or in some cases, entirely different from data they are trained on.

Artificial intelligence systems can include transformer models that are capable of running complex neural language processing tasks. Transformer models—also known as Large Language Models (LLMs)—have applications in a wide range of industries. An LLM is a trained deep learning model that can recognize, summarize, translate, predict, and generate content using very large datasets. LLMs and other types of generative AI models are associated with a training phase—where a model is taught to learn patterns, relationships, and knowledge from training datasets- and an inference phase, which includes making predictions, classifications, or generating outputs for real-world tasks or queries.

Unlike convolution neural networks (CNNs), which are typically used for image tasks and mostly rely on convolution operations, transformer models are based on simple general matrix multiplication (GEMM) tasks, which can be further broken down to perform a dot product operation on two vectors. While CNN architectures are typically computationally heavy with a relatively small number of parameters, the architecture of transformer models results in the opposite: a very large number of parameters with a fairly small number of operations. The LLM architecture can create challenges in that performance bottlenecks reside in the memory throughput and capacity rather than the compute engine.

Transformer models operate with memory accesses to retrieve a matrix of weights out of memory, together with a vector (either the input vector or partial result from a previous stage of the model), and multiplying the two. This is true for the model's attention sublayers, the FFN (feedforward network), sublayers, and for the final embedding layer. As vector-matrix multiplication is actually comprised of numerous vector-vector multiplications (dot product), it is fair to say that most memory accesses are used to read two vectors in order to perform a dot product on them. As such, reading out the full vectors is inefficient.

As such, transformer models (also referred to herein as “generative AI models”) require computational resources including processors and memory for the training phase and inference phase. The generative AI models operate with different types of processors (e.g., central processing units [CPUs] or graphics processing units [GPUs]) in architectures that include multi-core CPUs or parallel processors including GPUs and tensor processing units (TPUs). Memory can be used to store model parameters and intermediate data for the training phase and the inference phase. Memory requirements may depend on the size and the architecture of the generative AI models. By way of illustration, an LLM can support an inferencing phase that includes using a trained model to make predictions, draw conclusions, or generate output based on input data or patterns learned during the model's training phase. During the inference phase, an LLM can use DRAM (Dynamic Random-Access Memory) to store various components and data for making inferences. LLMs can store their pre-trained model parameters (e.g., weights and biases of the neural network layers) in DRAM, and when a new input is provided for inference, the model accesses these parameters from DRAM to make predictions.

The inference phase can be divided into two stages: a prompt stage and an auto-regressive stage. The prompt stage can include receiving and processing input as a batch of new tokens as part of the same inference. The prompt stage may operate based on a Key-Value (KV) cache technique, where a KV cache is created for tokens in a batch. During the prompt stage, the input is being digested. The auto-regressive state can include using the model to generate the tokens one by one, based on previous tokens, relying on reading the KV cache of previously processed tokens, and adding the data of only new tokens to the KV cache. This auto-regressive stage includes the model generating a response to the input from the prompt stage.

Referring now to FIG. 7, FIG. 7 provides an example of a computing device in which embodiments of the present disclosure may be employed. Computing device 700 includes bus 710 that directly or indirectly couples the following devices: memory 712, one or more processors 714, one or more presentation components 716, input/output (I/O) ports 718, input/output components 720, and illustrative power supply 722. Bus 710 represents what may be one or more buses (such as an address bus, data bus, or combination thereof). Although the various blocks of FIG. 7 are shown with lines for the sake of clarity, in reality, delineating various components is not so clear, and metaphorically, the lines would more accurately be gray and fuzzy. For example, one may consider a presentation component such as a display device to be an input/output (I/O) component. Also, processors have memory. The inventors recognize that such is the nature of the art and reiterate that the diagram of FIG. 7 is merely illustrative of an exemplary computing device that can be used in connection with one or more embodiments of the present technology. Distinction is not made between such categories as “workstation,” “server,” “laptop,” “handheld device,” etc., as all are contemplated within the scope of FIG. 7 and make reference to “computing device.”

Computing device 700 typically includes a variety of computer-readable media. Computer-readable media can be any available media that can be accessed by computing device 700 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium that can be used to store the desired information and which can be accessed by computing device 700. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, infrared, and other wireless media. Combinations of any of the above should also be included within the scope of computer-readable media.

Memory 712 includes computer storage media in the form of volatile and/or nonvolatile memory. As depicted, memory 712 includes instructions 724. Instructions 724, when executed by processor(s) 714, are configured to cause the computing device to perform any of the operations described herein, in reference to the above discussed figures, or to implement any program modules described herein. The memory may be removable, non-removable, or a combination thereof. Exemplary hardware devices include solid-state memory, hard drives, optical-disc drives, etc. Computing device 700 includes one or more processors that read data from various entities such as memory 712 or I/O components 720. Presentation component(s) 716 present data indications to a user or other device. Exemplary presentation components include a display device, speaker, printing component, vibrating component, etc.

I/O ports 718 allow computing device 700 to be logically coupled to other devices including I/O components 720, some of which may be built-in. Illustrative components include a microphone, joystick, game pad, satellite dish, scanner, printer, wireless device, etc. I/O components 720 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on computing device 700. Computing device 700 may be equipped with depth cameras, such as stereoscopic camera systems, infrared camera systems, camera systems, and combinations of these, for gesture detection and recognition. Additionally, computing device 700 may be equipped with accelerometers or gyroscopes that enable detection of motion. The output of the accelerometers or gyroscopes may be provided to the display of computing device 700 to render immersive augmented reality or virtual reality.

Embodiments presented herein have been described in relation to particular embodiments which are intended in all respects to be illustrative rather than restrictive. Alternative embodiments will become apparent to those of ordinary skill in the art to which the present disclosure pertains without departing from its scope.

Various aspects of the illustrative embodiments have been described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features have been omitted or simplified in order to not obscure the illustrative embodiments.

Various operations have been described as multiple discrete operations, in turn, in a manner that is most helpful in understanding the illustrative embodiments; however, the order of description should not be construed as to imply that these operations are necessarily order dependent. In particular, these operations need not be performed in the order of presentation. Further, descriptions of operations as separate operations should not be construed as requiring that the operations be necessarily performed independently and/or by separate entities. Descriptions of entities and/or modules as separate modules should likewise not be construed as requiring that the modules be separate and/or perform separate operations. In various embodiments, illustrated and/or described operations, entities, data, and/or modules may be merged, broken into further subparts, and/or omitted.

The phrase “in one embodiment” or “in an embodiment” is used repeatedly. The phrase generally does not refer to the same embodiment; however, it may. The terms “comprising,” “having,” and “including” are synonymous, unless the context dictates otherwise. The phrase “A/B” means “A or B.” The phrase “A and/or B” means “(A), (B), or (A and B).” The phrase “at least one of A, B, and C” means “(A), (B), (C), (A and B), (A and C), (B and C), or (A, B and C).”

1. A computing system comprising:
a processor; and
a non-transitory computer-readable medium having stored thereon instructions that when executed by the processor, cause the processor to perform operations including:
accessing a structured data object corresponding to a source workflow of a source application to generate a workflow graph data structure based on parsing the structured data object into a unified workflow class that normalizes workflows encoded in different domain-specific language (DSL) formats into a common internal representation and serializing the common internal representation of workflow activities and transitions of the source workflow into the workflow graph data structure;
causing a language model comprising a multi-head attention mechanism to generate a summary of the source workflow based on a prompt comprising the workflow graph data structure;
determining a mapping of the workflow activities to corresponding workflow activities of a destination application by computing similarity between the workflow activities to the corresponding workflow activities based on:
applying exact-name matching;
responsive to determining no exact-name match, applying a term frequency-inverse document frequency (TF-IDF) similarity technique; and
responsive to determining the TF-IDF similarity technique fails to satisfy a threshold similarity, applying a semantic similarity technique based on contextual embeddings of workflow activity descriptions;
causing the language model to generate, via a destination workflow summary generator, a corresponding summary of a destination workflow based on a corresponding prompt comprising the summary and the mapping;
generating a destination structured data object corresponding to the destination workflow of the destination application based on the corresponding summary by causing the language model to determine executable workflow activities of the destination workflow based on the corresponding summary; and
causing execution of the destination workflow based on the executable workflow activities of the destination structured data object.

2. The computing system of claim 1, the operations further including:
responsive to determining (1) no exact name match between a workflow activity to the corresponding workflow activities of the destination application and (2) a word embedding of a name of the workflow activity is below a threshold string similarity to word embeddings of names of the corresponding workflow activities of the destination application:
computing the similarity between the workflow activity to a corresponding workflow activity of the destination application based on a corresponding contextual embedding of a corresponding description of the corresponding workflow activity with a greatest semantic similarity to a contextual embedding of a description of the workflow activity.

3. The computing system of claim 1, the operations further including:
computing the similarity between a first workflow activity to a first corresponding workflow activity of the destination application using an exact name match technique;
responsive to determining no exact name match between a second workflow activity to the corresponding workflow activities of the destination application, computing the similarity between the second workflow activity to a corresponding second workflow activity of the destination application using the TF-IDF similarity technique; and
responsive to determining (1) no exact name match between a third workflow activity to the corresponding workflow activities of the destination application and (2) the third workflow activity is below a threshold string similarity to the corresponding workflow activities of the destination application using the TF-IDF similarity technique, computing the similarity between the third workflow activity to a corresponding third workflow activity of the destination application using the semantic similarity technique.

4. The computing system of claim 3, the operations further including:
computing the similarity between the second workflow activity to the corresponding second workflow activity of the destination application using the TF-IDF similarity technique based on a corresponding word embedding of a corresponding name of the corresponding second workflow activity above the threshold string similarity to a word embedding of a name of the second workflow activity.

5. The computing system of claim 3, the operations further including:
computing the similarity between the third workflow activity to the corresponding third workflow activity of the destination application using the semantic similarity technique based on a corresponding contextual embedding of a corresponding description of the corresponding third workflow activity above a threshold semantic similarity to a contextual embedding of a description of the third workflow activity.

6. The computing system of claim 1, the operations further including:
generating the executable workflow activities of the destination structured data object using a Retrieval-Augmented Generation (RAG)-based prompt engineering pipeline; and
causing the destination workflow to be executed by the destination application based on the executable workflow activities of the destination structured data object.

7. The computing system of claim 1, the operations further including:
parsing the structured data object to extract the workflow activities, the transitions, dependencies between the workflow activities, and associated parameters of the workflow activities, and wherein the workflow graph data structure comprises the workflow activities, the transitions, the dependencies between the workflow activities, and the associated parameters of the workflow activities.

8. The computing system of claim 1, wherein the structured data object is in a DSL format of the source application and the destination structured data object is in a different DSL format of the destination application.

9. The computing system of claim 1, wherein the workflow graph data structure is defined using incident encoding.

10. A non-transitory computer-readable medium storing executable instructions, which when executed by a processing device, cause the processing device to perform operations comprising:
accessing a structured data object corresponding to a source workflow of a source application;
parsing the structured data object into a unified workflow class that normalizes workflows encoded in different domain-specific language (DSL) formats into a common internal representation of workflow activities and transitions of the source workflow;
serializing the common internal representation of the workflow activities and the transitions of the source workflow into a workflow graph data structure;
generating a natural language (NL) summary of the source workflow based on applying a prompt, to a language model comprising a multi-head attention mechanism, comprising the workflow graph data structure and instructions to generate the NL summary;
determining a mapping of the workflow activities to corresponding workflow activities of a destination application by computing similarity between the workflow activities to the corresponding workflow activities based on:
applying exact-name matching;
responsive to determining no exact-name match, applying a term frequency-inverse document frequency (TF-IDF) similarity technique; and
responsive to determining the TF-IDF similarity technique fails to satisfy a threshold similarity, applying a semantic similarity technique based on contextual embeddings of workflow activity descriptions;
generating a corresponding NL summary of a destination workflow based on applying a corresponding prompt, to the language model, comprising the NL summary, the mapping, descriptions of the corresponding workflow activities, and instructions to generate the corresponding NL summary;
generating a destination structured data object corresponding to the destination workflow of the destination application by causing the language model to determine executable workflow activities of the destination workflow based on the corresponding NL summary; and
causing execution of the destination workflow based on the executable workflow activities of the destination structured data object.

11. The non-transitory computer-readable medium of claim 10, the operations further comprising:
responsive to determining (1) no exact name match between a workflow activity to the corresponding workflow activities of the destination application and (2) a word embedding of a name of the workflow activity is below a threshold string similarity to word embeddings of names of the corresponding workflow activities of the destination application:
computing the similarity between the workflow activity to a corresponding workflow activity of the destination application based on a corresponding contextual embedding of a corresponding description of the corresponding workflow activity with a greatest semantic similarity to a contextual embedding of a description of the workflow activity.

12. The non-transitory computer-readable medium of claim 10, the method operations further comprising:
computing the similarity between a first workflow activity to a first corresponding workflow activity of the destination application using an exact name match technique;
responsive to determining no exact name match between a second workflow activity to the corresponding workflow activities of the destination application, computing the similarity between the second workflow activity to a corresponding second workflow activity of the destination application using the TF-IDF similarity technique; and
responsive to determining (1) no exact name match between a third workflow activity to the corresponding workflow activities of the destination application and (2) the third workflow activity is below a threshold string similarity to the corresponding workflow activities of the destination application using the TF-IDF similarity technique, computing the similarity between the third workflow activity to a corresponding third workflow activity of the destination application using the semantic similarity technique.

13. The non-transitory computer-readable medium of claim 12, the operations further comprising:
computing the similarity between the second workflow activity to the corresponding second workflow activity of the destination application using the TF-IDF similarity technique based on a corresponding word embedding of a corresponding name of the corresponding second workflow activity above the threshold string similarity to a word embedding of a name of the second workflow activity.

14. The non-transitory computer-readable medium of claim 12, the operations further comprising:
computing the similarity between the third workflow activity to the corresponding third workflow activity of the destination application using the semantic similarity technique based on a corresponding contextual embedding of a corresponding description of the corresponding third workflow activity above a threshold semantic similarity to a contextual embedding of a description of the third workflow activity.

15. The non-transitory computer-readable medium of claim 10, the operations further comprising:
generating the executable workflow activities of the destination structured data object using a Retrieval-Augmented Generation (RAG)-based prompt engineering pipeline; and
causing the destination workflow to be executed by the destination application based on the executable workflow activities of the destination structured data object.

16. The non-transitory computer-readable medium of claim 10, the operations further comprising:
parsing the structured data object to extract the workflow activities, the transitions, dependencies between the workflow activities, and associated parameters of the workflow activities, and wherein the workflow graph data structure comprises the workflow activities, the transitions, the dependencies between the workflow activities, and the associated parameters of the workflow activities.

17. The non-transitory computer-readable medium of claim 10, wherein the structured data object is in a DSL format of the source application and the destination structured data object is in a different DSL format of the destination application.

18. The non-transitory computer-readable medium of claim 10, wherein the workflow graph data structure is defined using incident encoding.

19. A computer-implemented method comprising:
accessing a structured data object corresponding to a source workflow of a source application and a selection of a destination application;
parsing the structured data object into a unified workflow class that normalizes workflows encoded in different domain-specific language (DSL) formats into a common internal representation of workflow activities and transitions of the source workflow;
serializing the common internal representation of the workflow activities and the transitions of the source workflow into a workflow graph data structure;
causing a language model comprising a multi-head attention mechanism to generate a summary of the source workflow based on a prompt comprising the workflow graph data structure;
determining a mapping of the workflow activities to corresponding workflow activities of the destination application by computing similarity between the workflow activities to the corresponding workflow activities based on:
applying exact-name matching;
responsive to determining no exact-name match, applying a term frequency-inverse document frequency (TF-IDF) similarity technique; and
responsive to determining the TF-IDF similarity technique fails to satisfy a threshold similarity, applying a semantic similarity technique based on contextual embeddings of workflow activity descriptions;
causing the language model to generate a corresponding summary of a destination workflow based on a corresponding prompt comprising the summary, the mapping, and descriptions of the corresponding workflow activities;
generating a destination structured data object corresponding to the destination workflow of the destination application by causing the language model to determine executable workflow activities of the destination workflow based on the corresponding summary; and
causing execution of the destination workflow based on the executable workflow activities of the destination structured data object.

20. The computer-implemented method of claim 19, further comprising:
responsive to determining (1) no exact name match between a workflow activity to the corresponding workflow activities of the destination application and (2) a word embedding of a name of the workflow activity is below a threshold string similarity to word embeddings of the names of the corresponding workflow activities of the destination application:
computing the similarity between the workflow activity to a corresponding workflow activity of the destination application based on a corresponding contextual embedding of a corresponding description of the corresponding workflow activity with a greatest semantic similarity to a contextual embedding of a description of the workflow activity.
